(19) United States
(12) Patent Application Publication
(10) Pub. No.: US 2026/0205178 A1
(43) Pub. Date: Jul. 16, 2026

(54) SIGNAL QUALITY EQUIVALENCE BASED PRECODING FOR WIRELESS DEVICES

(71) Applicant: QUALCOMM Incorporated, San Diego, CA (US)

(72) Inventors: Chih-Hao LIU, San Diego, CA (US); Yu ZHANG, San Diego, CA (US); Wei YANG, San Diego, CA (US); Tzu-Hsuan CHOU, San Diego, CA (US)

(21) Appl. No.: 19/021,871

(22) Filed: Jan. 15, 2025

(51) Int. Cl. H04B 7/06

(52) U.S. Cl. CPC H04B 7/0626; H04B 7/0639

(57) ABSTRACT

Various aspects of the present disclosure generally relate to wireless communication. In some aspects, a user equipment (UE) may transmit, to a network node, capability information that indicates support for a signal quality equivalence based precoding for wireless messages. The UE may receive, from the network node, one or more reference signals associated with measurement of a signal quality associated with a transmission channel. In some examples, the transmission channel may be associated with a set of spatial layers. The UE may transmit, to the network node, a channel state information (CSI) report associated with the transmission channel that indicates one or more CSI parameters associated with equalizing signal quality across the set of spatial layers in accordance with supporting the signal quality equivalence based precoding. Numerous other aspects are described.

### FIELD OF THE DISCLOSURE

Aspects of the present disclosure generally relate to wireless communication and specifically relate to techniques, apparatuses, and methods associated with signal quality equivalence based precoding for wireless devices.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

In some examples, a network node and a user equipment (UE) may operate in accordance with channel state information (CSI) reporting. For example, as part of CSI reporting, the UE may provide feedback to the network node about one or more downlink channel conditions. The UE may measure the channel quality using reference signals (e.g., CSI reference signals) transmitted by the network node and may generate one or more metrics such as a channel quality indicator, a rank indicator, and a precoding matrix indicator. The feedback may enable the network node to optimize its transmission strategies, including selecting a modulation and coding scheme, a number of spatial layers, and a precoding matrix for beamforming. CSI reporting can be periodic, aperiodic, or semi-persistent, depending on the configuration set by the network node.

### SUMMARY

Some aspects described herein relate to a user equipment (UE) for wireless communication. The UE may include one or more memories and one or more processors coupled to the one or more memories. The one or more processors may be configured, individually or in any combination, to transmit, to a network node, capability information that indicates support for a signal quality equivalence based precoding for wireless messages. The one or more processors may be configured, individually or in any combination, to receive, from the network node, one or more reference signals associated with measurement of a signal quality associated with a transmission channel, wherein the transmission channel is associated with a set of spatial layers. The one or more processors may be configured to, individually or in any combination, transmit, to the network node, a channel state information (CSI) report associated with the transmission channel that indicates one or more CSI parameters associated with equalizing signal quality across the set of spatial layers in accordance with supporting the signal quality equivalence based precoding.

Some aspects described herein relate to a network node for wireless communication. The network node may include one or more memories and one or more processors coupled to the one or more memories. The one or more processors may be configured to, individually or in any combination, receive, from a UE, capability information that indicates support for a signal quality equivalence based precoding for wireless messages. The one or more processors may be configured, individually or in any combination, to transmit, to the UE, one or more reference signals associated with measurement of a signal quality associated with a transmission channel, wherein the transmission channel is associated with a set of spatial layers. The one or more processors may be configured, individually or in any combination, to receive, from the UE, a CSI report associated with the transmission channel that indicates one or more CSI parameters associated with equalizing signal quality across the set of spatial layers in accordance with supporting the signal quality equivalence based precoding.

Some aspects described herein relate to a method of wireless communication performed by a UE. The method may include transmitting, to a network node, capability information that indicates support for a signal quality equivalence based precoding for wireless messages. The method may include receiving, from the network node, one or more reference signals associated with measurement of a signal quality associated with a transmission channel, wherein the transmission channel is associated with a set of spatial layers. The method may include transmitting, to the network node, a CSI report associated with the transmission channel that indicates one or more CSI parameters associated with equalizing signal quality across the set of spatial layers in accordance with supporting the signal quality equivalence based precoding.

Some aspects described herein relate to a method of wireless communication performed by a network node. The method may include receiving, from a UE, capability information that indicates support for a signal quality equivalence based precoding for wireless messages. The method may include transmitting, to the UE, one or more reference signals associated with measurement of a signal quality associated with a transmission channel, wherein the transmission channel is associated with a set of spatial layers. The method may include receiving, from the UE, a CSI report associated with the transmission channel that indicates one or more CSI parameters associated with equalizing signal quality across the set of spatial layers in accordance with supporting the signal quality equivalence based precoding.

Some aspects described herein relate to a non-transitory computer-readable medium that stores a set of instructions for wireless communication by a UE. The set of instructions, when executed by one or more processors of the UE, may cause the UE to transmit, to a network node, capability information that indicates support for a signal quality equivalence based precoding for wireless messages. The set of instructions, when executed by one or more processors of the UE, may cause the UE to receive, from the network node, one or more reference signals associated with measurement of a signal quality associated with a transmission channel, wherein the transmission channel is associated with a set of spatial layers. The set of instructions, when executed by one or more processors of the UE, may cause the UE to transmit, to the network node, a CSI report associated with the transmission channel that indicates one or more CSI parameters associated with equalizing signal quality across the set of spatial layers in accordance with supporting the signal quality equivalence based precoding.

Some aspects described herein relate to a non-transitory computer-readable medium that stores a set of instructions for wireless communication by a network node. The set of instructions, when executed by one or more processors of the network node, may cause the network node to receive, from a UE, capability information that indicates support for a signal quality equivalence based precoding for wireless messages. The set of instructions, when executed by one or more processors of the network node, may cause the network node to transmit, to the UE, one or more reference signals associated with measurement of a signal quality associated with a transmission channel, wherein the transmission channel is associated with a set of spatial layers. The set of instructions, when executed by one or more processors of the network node, may cause the network node to receive, from the UE, a CSI report associated with the transmission channel that indicates one or more CSI parameters associated with equalizing signal quality across the set of spatial layers in accordance with supporting the signal quality equivalence based precoding.

Some aspects described herein relate to an apparatus for wireless communication. The apparatus may include means for transmitting, to a network node, capability information that indicates support for a signal quality equivalence based precoding for wireless messages. The apparatus may include means for receiving, from the network node, one or more reference signals associated with measurement of a signal quality associated with a transmission channel, wherein the transmission channel is associated with a set of spatial layers. The apparatus may include means for transmitting, to the network node, a CSI report associated with the transmission channel that indicates one or more CSI parameters associated with equalizing signal quality across the set of spatial layers in accordance with supporting the signal quality equivalence based precoding.

Some aspects described herein relate to an apparatus for wireless communication. The apparatus may include means for receiving, from a UE, capability information that indicates support for a signal quality equivalence based precoding for wireless messages. The apparatus may include means for transmitting, to the UE, one or more reference signals associated with measurement of a signal quality associated with a transmission channel, wherein the transmission channel is associated with a set of spatial layers. The apparatus may include means for receiving, from the UE, a CSI report associated with the transmission channel that indicates one or more CSI parameters associated with equalizing signal quality across the set of spatial layers in accordance with supporting the signal quality equivalence based precoding.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of physical channels and reference signals in a wireless network, in accordance with the present disclosure.

FIG. 4 is a diagram illustrating an example of wireless message precoding and demapping, in accordance with the present disclosure.

FIG. 5 is a diagram illustrating an example associated with signal quality equivalence based precoding across a set of spatial layers, in accordance with the present disclosure.

FIG. 6 is a diagram illustrating an example process performed, for example, at a user equipment (UE) or an apparatus of a UE, in accordance with the present disclosure.

FIG. 7 is a diagram illustrating an example process performed, for example, at a network node or an apparatus of a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples of wireless communications, a network node and a user equipment (UE) may perform channel state information (CSI) reporting. For example, in a type-1 CSI reporting procedure, the UE may generate and transmit feedback to the network node based on measured downlink channel conditions. In some examples, the feedback may include metrics such as the channel quality indicator (CQI), rank indicator (RI), and a precoding matrix indicator (PMI). The type-1 CSI report may provide a coarse representation of the channel, which may enable the network node to determine the rank (number of spatial layers) and select a precoding matrix. In some examples, after receiving the type-1 CSI report, the network node may employ a singular value decomposition (SVD) precoder. An SVD precoder may be associated with channel matrix decomposition to increase a quality of a wireless transmission by aligning data streams along the strongest channel directions of a transmission channel.

In some cases, however, SVD precoding may introduce an uneven signal-to-noise ratio (SNR) across the spatial layers of the transmission channel. The uneven SNR may occur based on the singular values in the SVD decomposition representing the respective strength of each spatial layer individually. Consequently, certain layers may be associated with an SNR above an SNR threshold, allowing efficient decoding, while others may be associated with an SNR below the SNR threshold. In some examples, spatial layers associated with a lower SNR may dominate the overall performance and can degrade the reliability of decoding at the UE.

In some examples, the network node and UE may operate in accordance with a type of precoding that is associated with balancing and/or equalizing signal quality across the set of spatial streams. For example, geometric mean decomposition (GMD) and uniform channel decomposition (UCD) are precoding techniques designed to address uneven SNR across spatial layers in multiple-input multiple-output (MIMO) systems. Both GMD and UCD may balance and/or equalize the SNR across spatial layers, enabling a more consistent performance for multi-layer transmissions and improving system reliability and throughput. A UE may be able to receive and decode GMD/UCD precoded messages based on a reception component of the UE supporting GMD/UCD. However, the network node may be unaware of whether the UE supports GMD/UCD decoding. Therefore, if the network node transmits a wireless message precoded via GMD or UCD and the UE does not support GMD or UCD decoding, then the UE may be unable to decode the message and/or be unable to benefit from the increased decoding reliability associated with balanced SNR across the set of spatial streams.

Various aspects relate generally to enabling signal quality equivalence based precoding across a set of spatial streams. Some aspects more specifically relate to the UE transmitting, and the network node receiving, capability information that indicates support for signal quality equivalence based precoding for wireless messages. In other words, the UE may indicate that an associated reception component supports GMD and/or UCD decoding. In some aspects, the network node may configure the UE with a type of CSI report that includes one or more CSI parameters associated with equalizing signal quality across the set of spatial layers. In some examples, the CSI report may be configured to include a single set of CSI parameters associated with indicating one or more of a PMI, RI, or CQI associated with GMD and/or UCD decoding. In some examples, the CSI report may be configured to include a first set of CSI parameters associated with SVD or open loop precoding and a second set of CSI parameters associated with GMD and/or UCD precoding. In some examples, the network node may dynamically indicate whether a CSI report is to include one or more of the first set of CSI parameters or the second set of CSI parameters. In some aspects, the UE may transmit the CSI report which may include one or more CSI parameters associated with equalizing signal quality across the set of spatial layers. In accordance with the one or more CSI parameters of the CSI report, the network node may generate a GMD and/or UCD precoder to use for one or more subsequent transmissions.

Particular aspects of the subject matter described in this disclosure can be implemented to realize one or more of the following potential advantages. In some examples, the described techniques can be used to increase a probability of wireless message decoding at the UE. For example, based on the UE indicating support for GMD and/or UCD precoding, the network node may use a precoder that equalizes SNR across the spatial streams of the transmission. Therefore, the UE may decode a wireless message across the set of spatial streams associated with balanced SNR, which may increase the signal quality and probability of decoding the wireless message. Additionally, the described techniques can enable a reduction in signaling overhead. For example, based on the network node dynamically configuring which CSI parameters to include in the CSI report, the network node may reduce the payload included in the CSI report, which may reduce signaling overhead.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

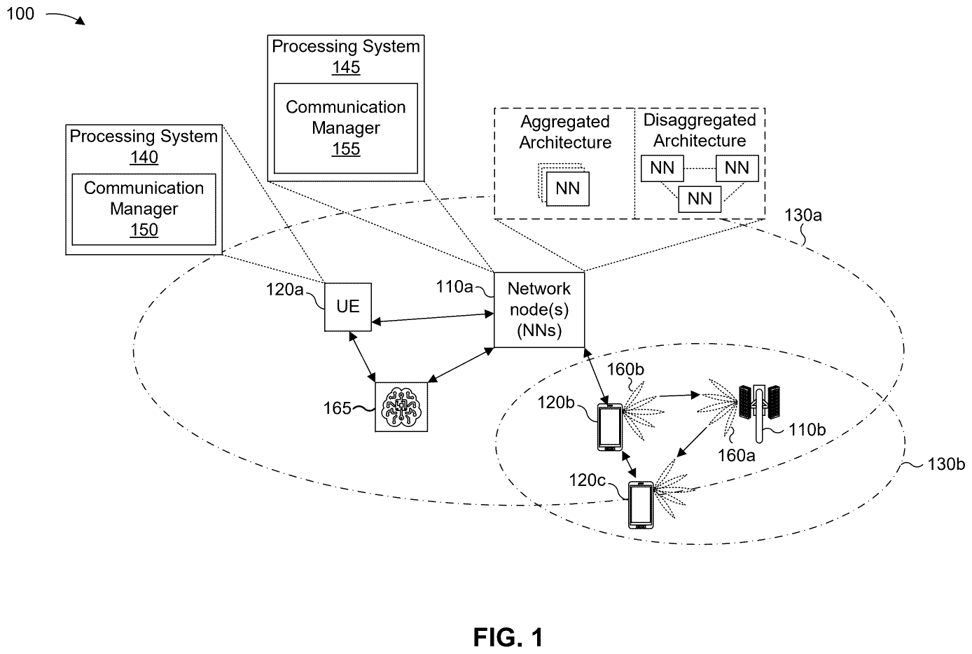

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

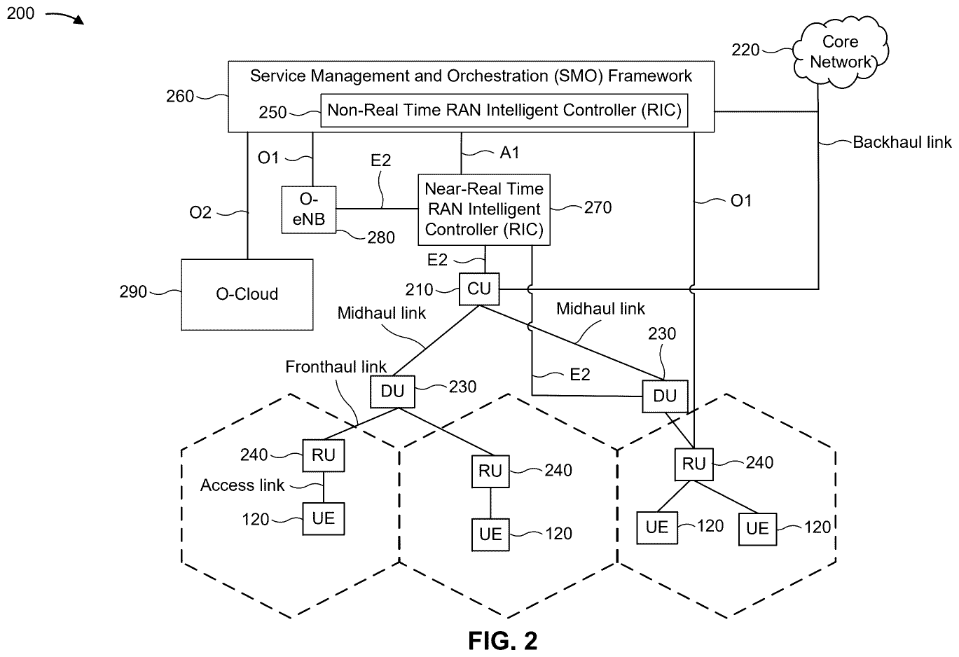

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a CSI reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a CQI (indicative of downlink channel conditions to facilitate selection of transmission parameters, such as an MCS, by a network node 110), a PMI, a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), an RI, and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, a UE 120 may include a communication manager 150. As described in more detail elsewhere herein, the communication manager 150 may transmit, to a network node, capability information that indicates support for a signal quality equivalence based precoding for wireless messages; receive, from the network node, one or more reference signals associated with measurement of a signal quality associated with a transmission channel, wherein the transmission channel is associated with a set of spatial layers; and transmit, to the network node, a CSI report associated with the transmission channel that indicates one or more CSI parameters associated with equalizing signal quality across the set of spatial layers in accordance with supporting the signal quality equivalence based precoding. Additionally, or alternatively, the communication manager 150 may perform one or more other operations described herein.

In some aspects, a network node 110 may include a communication manager 155. As described in more detail elsewhere herein, the communication manager 155 may receive, from a UE, capability information that indicates support for a signal quality equivalence based precoding for wireless messages; transmit, to the UE, one or more reference signals associated with measurement of a signal quality associated with a transmission channel, wherein the transmission channel is associated with a set of spatial layers; and receive, from the UE, a CSI report associated with the transmission channel that indicates one or more CSI parameters associated with equalizing signal quality across the set of spatial layers in accordance with supporting the signal quality equivalence based precoding. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

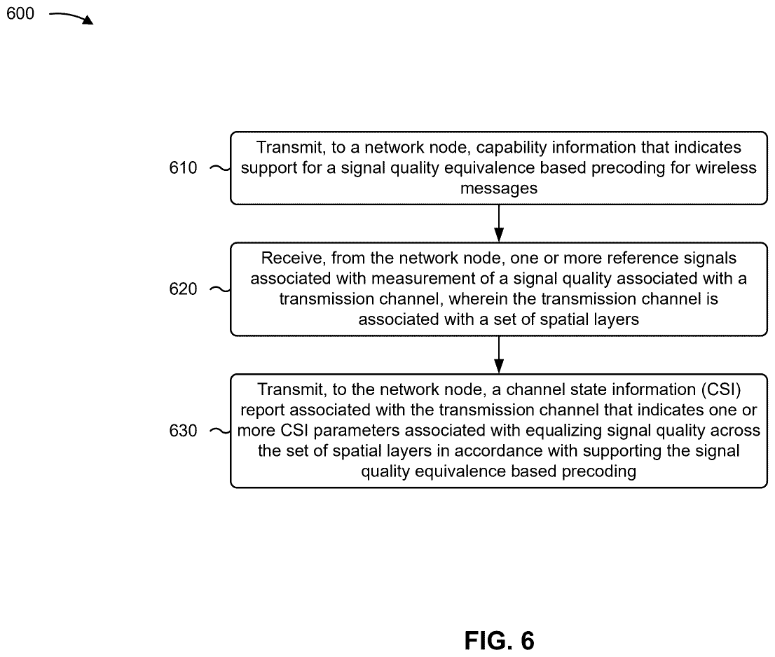

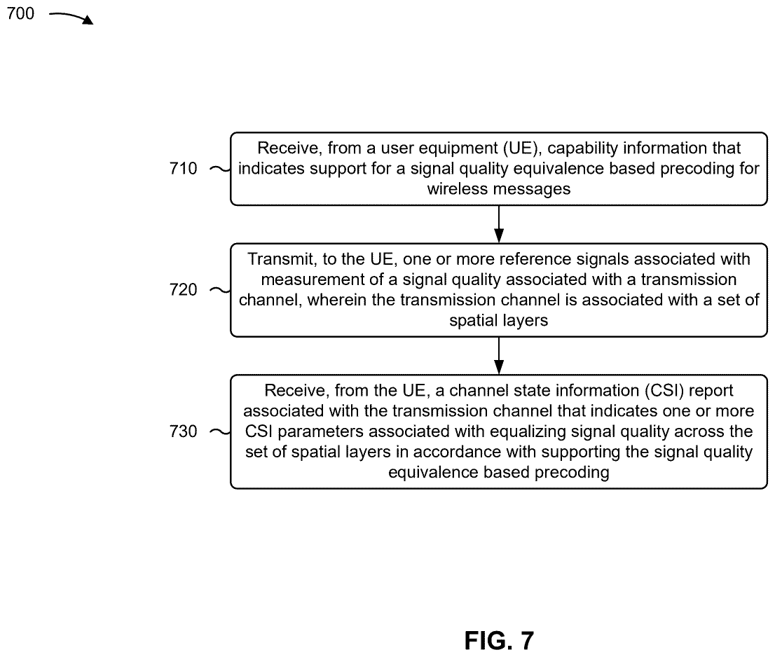

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with signal quality equivalence based precoding for wireless devices, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, and/or interpreting the instructions, among other examples.

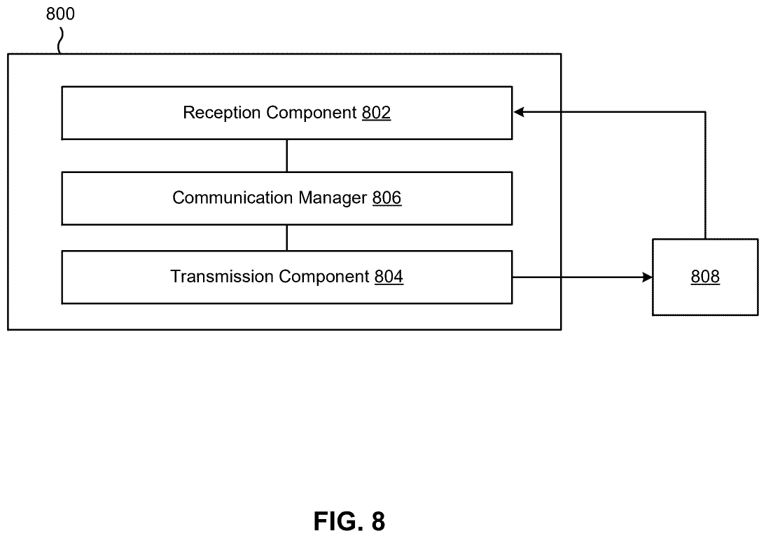

In some aspects, a UE includes means for transmitting, to a network node, capability information that indicates support for a signal quality equivalence based precoding for wireless messages; means for receiving, from the network node, one or more reference signals associated with measurement of a signal quality associated with a transmission channel, wherein the transmission channel is associated with a set of spatial layers; and/or means for transmitting, to the network node, a CSI report associated with the transmission channel that indicates one or more CSI parameters associated with equalizing signal quality across the set of spatial layers in accordance with supporting the signal quality equivalence based precoding. The means for the UE to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

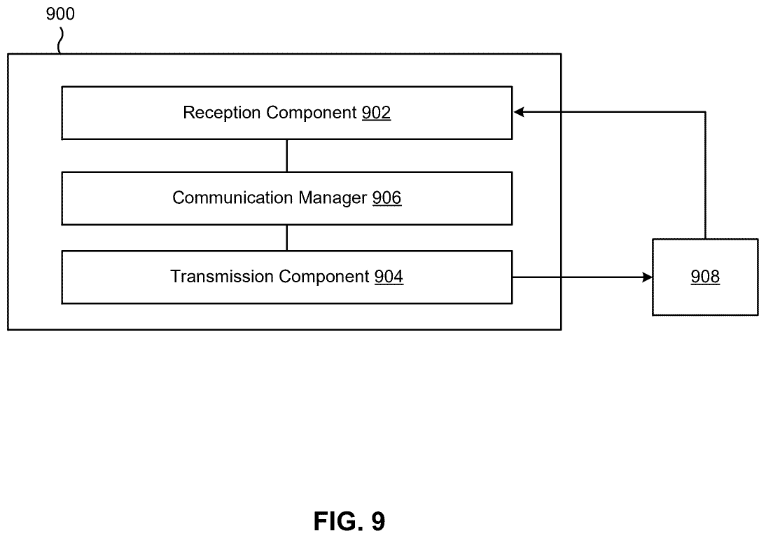

In some aspects, a network node includes means for receiving, from a UE, capability information that indicates support for a signal quality equivalence based precoding for wireless messages; means for transmitting, to the UE, one or more reference signals associated with measurement of a signal quality associated with a transmission channel, wherein the transmission channel is associated with a set of spatial layers; and/or means for receiving, from the UE, a CSI report associated with the transmission channel that indicates one or more CSI parameters associated with equalizing signal quality across the set of spatial layers in accordance with supporting the signal quality equivalence based precoding. The means for the network node to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

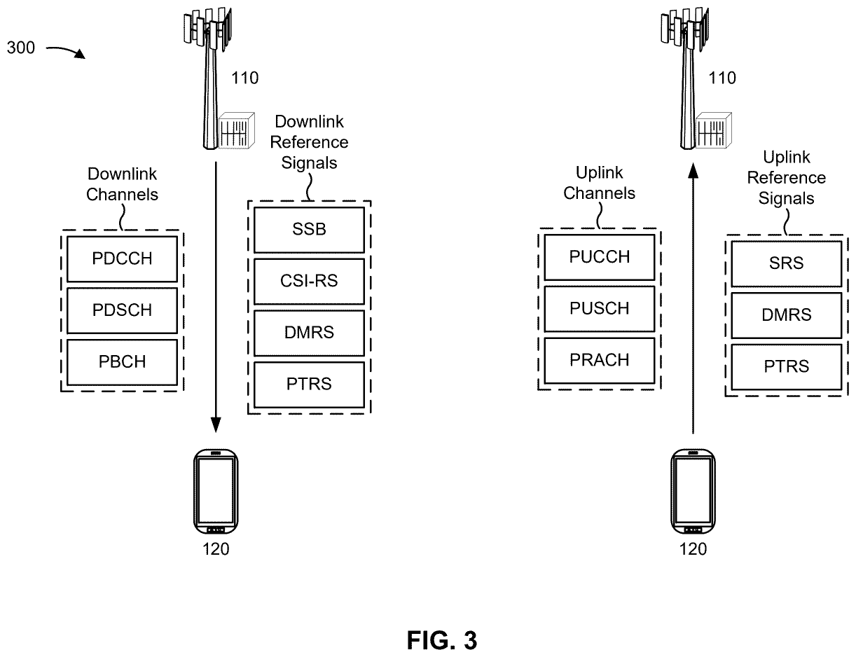

FIG. 3 is a diagram illustrating an example 300 of physical channels and reference signals in a wireless network, in accordance with the present disclosure. As shown in FIG. 3, downlink channels and downlink reference signals may carry information from a network node 110 to a UE 120, and uplink channels and uplink reference signals may carry information from a UE 120 to a network node 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a CSI reference signal (CSI-RS), a demodulation reference signal (DMRS), a positioning reference signal (PRS), or a phase tracking reference signal (PTRS), among other examples. As also shown, an uplink reference signal may include an SRS, a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a CQI, a PMI, a CSI-RS resource indicator (CRI), a layer indicator (LI), an RI, or a reference signal received power (RSRP), among other examples. The network node 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 3 is provided as an example. Other examples may differ from what is described with regard to FIG. 3.

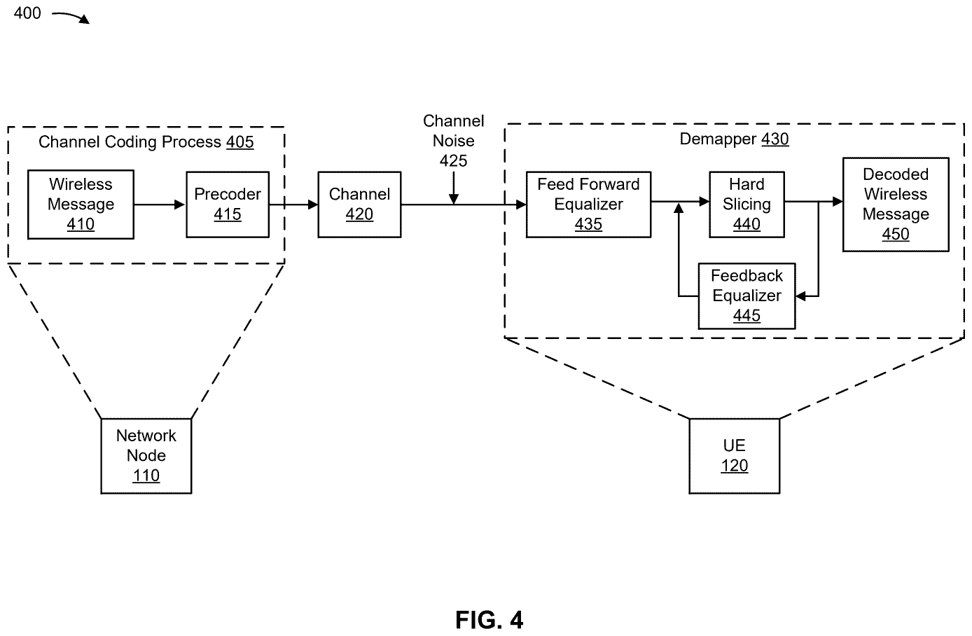

FIG. 4 is a diagram illustrating an example 400 of wireless message precoding and demapping, in accordance with the present disclosure. In some instances, example 400 may implement or be implemented by one or more aspects of FIGS. 1 through 3. For instance, FIG. 4 may illustrate wireless communications between the network node 110 and the UE 120.

In some examples, aspects of example 400 may support and/or be associated with MIMO precoding. For example, MIMO precoding may be categorized into codebook-based and non-codebook-based approaches. In some examples, codebook-based precoding may be associated with a predefined and/or preconfigured set of precoding matrices, or “codebooks” (e.g., defined in a wireless communications standard, such as 3GPP). Accordingly, the network node 110 may select a precoding matrix from the set of precoding matrices based on feedback from the UE 120. For instance, the UE 120 may transmit a CSI report that indicates a PMI, guiding the network node 110 in selecting the matrix that increases signal quality and reduces interference. Therefore, codebook-based MIMO precoding may increase computational efficiency at the network node 110 and the UE 120, and reduce signaling overhead based on leveraging the predefined set of precoding matrices. In contrast, non-codebook-based precoding may increase flexibility by enabling the network node 110 to compute precoding matrices dynamically, based on real-time channel state information. Therefore, non-codebook-based precoding may provide an increased adaptability to diverse and evolving channel environments but may increase computational complexity and/or signaling overhead.

In some examples, the network node 110 may use one or more of codebook-based or non-codebook-based MIMO precoding to transmit a codeword. For example, a codeword may be an encoded representation of a wireless message 410 (e.g., a transport block). The codeword may include original data bits and additional redundancy bits introduced during a channel coding process 405 at the network node 110. In some examples, the codeword may be the unit of data transmission over the physical layer, which may enable robustness against channel impairments (such as noise and/or interference). Therefore, transmission of the codeword by the network node enables the UE 120 to detect and correct errors, improving the reliability of communication.

In some examples, the network node 110 may transmit one or more codewords concurrently in MIMO systems, in accordance with a rank of transmission. For instance, transmission of one codeword may be supported if the number of associated layers (e.g., spatial layers or spatial streams) is less than or equal to four. Additionally, concurrent transmission of up to two codewords may be supported if the number of associated spatial layers is greater than four. In some examples, the number of concurrent codeword transmissions via a number of MIMO spatial layers may be based on and/or in accordance with a hardware implementation at the network node 110 and/or the UE 120. In some examples, any number of the codewords may be concurrently transmitted via any number of spatial layers.

In some examples, a set of MIMO spatial layers may be respectively associated with a set of signal quality values relative to a channel noise 425. With reference to example 400, signal quality of a spatial layer may be described with reference to signal-to-noise ratio (SNR). However, in other implementations of example 400, “signal quality” may refer to one or more other signal quality metrics, such as one or more of reference signal received power (RSRP), reference signal received quality (RSRQ), signal-to-interference-plus-noise ratio (SINR), CQI, block error rate (BLER), bit error rate (BER), error vector magnitude (EVM), demodulation reference signal SINR (DMRS-SINR), and/or received signal strength indicator (RSSI).

In some examples, the channel coding process 405 may be associated with singular value decomposition (SVD) precoding. For example, SVD precoding may decompose the channel matrix into a set of components that includes a first unitary matrix representing the network node 110 spatial directions, a diagonal matrix that includes values associated with channel gain for each spatial layer, and a second unitary matrix associated with the UE 120 spatial directions. The SVD decomposition may enable the network node 110 to precode data streams in alignment with a set of eigenmodes associated with a channel 420 used for transmission. In some examples, aligning the precoded data streams with the set of eigenmodes may respectively increase the SNR across the set of spatial layers, which may result in a different SNR associated with each spatial layer.

In accordance with codebook-based and non-codebook-based MIMO precoding, spatial layer SNR imbalance may reduce the quality of a codeword transmission. For example, in cases where a coding rate associated with transmission is above a coding rate threshold (e.g., a relatively high coding rate), decoding at the UE 120 may be relative to a spatial layer associated with the lowest SNR. In other words, decoding performance at the UE 120 may be limited by the lowest SNR across a set of MIMO spatial layers, which may reduce an ability of the UE 120 to decode the received codeword.

In some other examples, the channel coding process 405 may be associated with a precoding procedure that enables equalizing signal quality across a set of MIMO spatial layers. For example, the network node 110 may use a precoder 415 associated with balancing SNR across the set of MIMO spatial layers. In some examples, the precoder 415 may be associated with GMD precoding. For example, GMD may be associated with the network node 110 transforming the channel matrix into a form that equalizes the SNR across multiple spatial layers, enabling balanced performance for all transmitted data streams. In some examples, the GMD precoding process may be associated with the network node 110 receiving a CSI report from the UE 120 (such as through uplink feedback or reference signal measurements). In accordance with one or more CSI parameters included in the CSI report, the network node 110 may perform a decomposition of the channel matrix into components that represent the spatial characteristics channel 420. Additionally, applying GMD may modify the decomposition such that each spatial layer experiences approximately the same effective SNR (e.g., the difference between the SNR of each spatial layer is less than a tolerance threshold). For example, if the number of spatial layers of the channel 420 is three, and the effective SNR is equal to A, then a channel matrix H associated with the channel 420 may be in accordance with Equation 1:

$$H = [ \begin{matrix}\overline{λ} & 0 & 0 \\ 0 & \overline{λ} & 0 \\ 0 & 0 & \overline{λ}\end{matrix} ] \qquad ( 1 )$$

where the set of diagonal values of the channel matrix H are respectively associated with the set of spatial layers of the channel 420. That is, each column of the channel matrix H may be associated with a respective stream of the channel 420.

Additionally, determining the precoder 415 applied to the channel 420 may be associated with a decomposition of the channel matrix H in accordance with Equation 2:

$$H = Q R {P}^{H} = Q [ \begin{matrix}\overline{λ} & * & * \\ ⋮ & ⋱ & * \\ 0 & … & \overline{λ}\end{matrix} ] {P}^{H} \qquad ( 2 )$$

For example, matrix Q and matrix P may both be examples of a unitary matrix. Additionally, the matrix P may be equal to the precoder 415 that the network node 110 uses in accordance with GMD precoding. In some examples, the matrix R may be an N×N matrix, where N is the number of spatial layers of the channel 420. Additionally, the matrix R may be an upper triangular matrix, where each value across the diagonal of the matrix R is equal to A (e.g., the effective SNR for each spatial layer).

In some examples, the UE 120 may operate in accordance with a demapper 430 to decode the wireless message 410 that the network node 110 transmitted in accordance with GMD precoding. In example 400, the demapper 430 may be associated with decision feedback equalization (DFE) demapping. In accordance with DFE demapping, the UE 120 may decompose the channel matrix using GMD to balance the SNR across spatial layers (e.g., in accordance with matrix Q and matrix R (QR) decomposition, with reference to Equation 2). In some examples, as part of DFE demapping, the UE 120 may apply a feed forward equalizer 435 to the received signal. For example, the feed forward equalizer 435 (e.g., G) may be defined in accordance with Equation 3:

$$G = \frac{1}{\overline{λ}} {Q}^{H} \qquad ( 3 )$$

After applying the feed forward equalizer 435, the UE 120 may decode the spatial layers of the received signal sequentially. For example, the UE 120 may begin with decoding a first spatial layer of the channel 420. The first spatial layer may be decoded in accordance with hard slicing 440. For example, the hard slicing 440 (in the context of demapping for GMD precoding) may include the process of directly mapping a received signal point in the QAM constellation to the nearest constellation symbol (e.g., without considering additional probabilistic or soft information about the signal). In QAM, each transmitted symbol may correspond to a specific point in the constellation, representing a combination of amplitude and phase. During the hard slicing 440, the demapper 430 examines the location of the received signal for the first spatial layer in the complex plane and assigns the location to the nearest valid symbol in the QAM constellation. In some examples, the hard slicing 440 may be computationally simple and fast compared to a process such as soft demapping based on the hard slicing 440 not accounting for channel impairments such as noise or interference beyond QAM distance measurements. Additionally, in systems employing GMD precoding (where SNR across spatial layers is equalized), the reliability associated with hard slicing may be increased based on the balanced SNR reducing the probability of incorrect symbol decisions.

In accordance with decoding the data associated with the first spatial layer of the channel 420, the UE 120 may use the decoded data to reconstruct and subtract the interference that the first spatial layer causes on the remaining spatial layers. For example, after decoding the data of the first spatial layer, the UE 120 may apply a feedback equalizer 445. The feedback equalizer 445 (e.g., B) may be defined in accordance with Equation 4:

$$B = ( \frac{1}{\overline{λ}} R - I ) \qquad ( 4 )$$

In accordance with applying feedback equalizer 445, the UE 120 may reduce the signal interference associated with the first spatial layer. Therefore, the UE 120 may continue with decoding the data associated with a second spatial layer of the channel 420. For instance, the UE 120 may perform the hard slicing 440 for the second spatial layer and then apply the feedback equalizer 445 to reduce the signal interference associated with the second spatial layer. In some examples, as part of DFE demapping, the UE 120 may iteratively perform the hard slicing 440 and the feedback equalizer for each spatial layer of the channel 420. Accordingly, the UE 120 may generate a decoded wireless message 450 in accordance with the demapper 430.

By leveraging GMD to equalize SNR across spatial layers, DFE demapping operates in a reduced error-prone environment, improving an effectiveness of DFE demapping. Additionally, the use of the feedback equalizer 445 in DFE demapping may allow the UE 120 to account for inter-spatial layer dependencies dynamically. Additionally, GMD precoding may balance SNR across spatial layers of the channel 420, which ensures that no single spatial layer dominates or becomes excessively weak, enhancing the overall reliability of the DFE demapping process. Therefore, the combination of GMD precoding and DFE demapping enables efficient and robust decoding of MIMO transmissions between the network node 110 and the UE 120.

With reference to example 400, the network node 110 and UE 120 may operate in accordance with GMD precoding. However, in other implementations, the network node 110 and UE 120 may operate in accordance with any type of precoding technique that balances and/or equalizes signal quality across the set of MIMO spatial layers associated with the channel 420. For instance, one or more aspects of example 400 may be performed in accordance with UCD based precoding. In some examples, UCD based precoding is a technique used in MIMO systems to balance the performance of spatial layers for efficient data transmission. In some examples, UCD is associated with decomposing the channel 420 into parallel subchannels with uniform capacities, which may enable each spatial layer to have comparable signal quality and reliability. This decomposition may allow the network node 110 to allocate data streams evenly across the spatial layers, increasing throughput while maintaining balanced performance. UCD may be particularly effective in scenarios where a difference in channel conditions across spatial layers is above a difference threshold, as UCD may mitigate the disparities in SNR by enabling each spatial layer to have a similar effective channel quality. By achieving uniformity in the channel capacity, UCD based precoding reduces the risk of weaker spatial layers dominating decoding performance (e.g., spatial layers associated with lower SNR values).

With reference to example 400, the UE 120 may operate in accordance with GMD based decoding. However, in other implementations the UE 120 may operate in accordance with any type of decoding technique associated with balancing and/or equalizing signal quality across the set of MIMO spatial layers associated with the channel 420. For instance, the UE 120 may operate in accordance with partial successive reduction decoding (PSRD). In some examples, PSRD is associated with QR decomposition of the channel matrix H, which transforms the channel matrix H into two components (e.g., matrix Q and matrix R, as described with reference to Equation 2). Additionally, PSRD may incorporate and/or be associated with tree search algorithms (e.g., sphere decoding or K-best search) to identify highest probability symbol vectors of each data stream transmitted via the channel 420. Additionally, PSRD may incorporate and/or be associated with partial reduction where the UE 120 uses intermediate decisions of previously decoded spatial layers of the channel 420 to guide the search and decoding of subsequent spatial layers of the channel 420. In some cases, GMD and/or PSRD based decoding may initiate decoding on a last spatial layer of the channel 420 for each iteration of spatial layer decoding.

With reference to example 400, the UE 120 may operate in accordance with DFE demapping (e.g., using the demapper 430). However, in other implementations, the demapper 430 may use any demapping techniques associated with balancing and/or equalizing signal quality across the set of MIMO spatial layers associated with the channel 420. For example, the demapper 430 may use vertical Bell Laboratories spatial layered space-time (vBLAST) demapping or any QR based demapping.

Therefore, based on the network node 110 generating a precoder 415 associated with GMD or UCD precoding and the UE 120 operating in accordance with the demapper 430 associated with DFE, vBLAST, or some other QR decomposition based demapping, the SNRs across the spatial layers of channel 420 may be equalized and/or balanced, which may increase the data rate of the channel 420 relative to the Shannon capacity of the channel 420 (e.g., the theoretical maximum data rate that the channel 420 may achieve).

As indicated above, FIG. 4 is provided as an example. Other examples may differ from what is described with regard to FIG. 4.

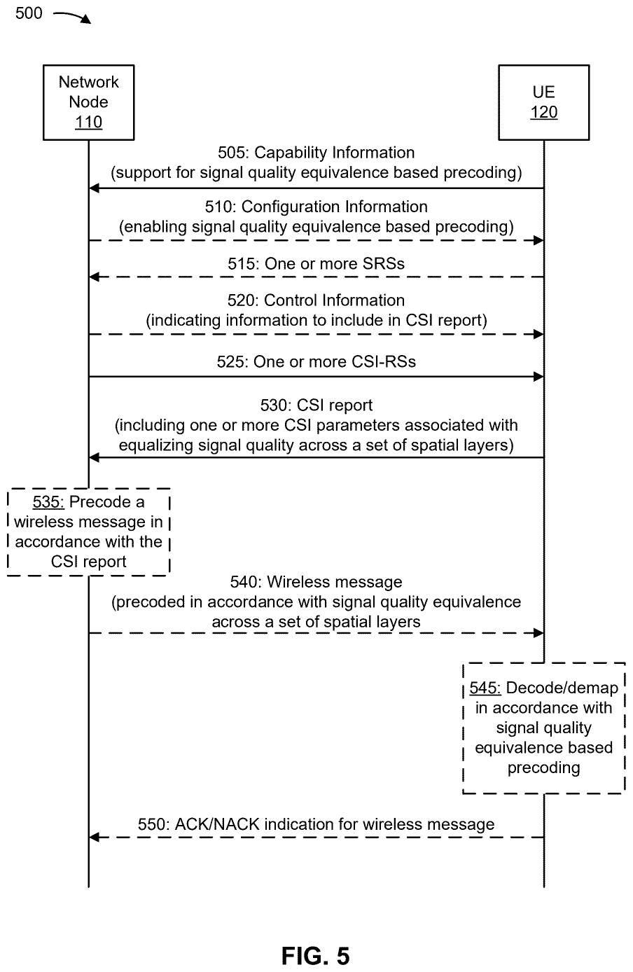

FIG. 5 is a diagram illustrating an example 500 associated with signal quality equivalence based precoding across a set of spatial layers, in accordance with the present disclosure. Example 500 may implement or be implemented by one or more aspects of FIGS. 1 through 4. For instance, example 500 includes wireless communications between the network node 110 and the UE 120. Alternative examples of the following may be implemented, where some operations are performed in a different order than described, or not described at all. In some cases, one or more operations may include additional features not mentioned below, or further operations may be added. In addition, while example 500 shows operations between the UE 120 and the network node 110, the communication may occur between any number of network devices of various types described herein.

In a first operation 505, the UE 120 may transmit, and the network node 110 may receive, capability information. The capability information may be included in a capability report. The UE 120 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a sidelink channel (e.g., a physical sidelink control channel (PSCCH), and/or a physical sidelink shared channel (PSSCH)), among other examples. The capability information may indicate one or more parameters associated with respective capabilities of the UE 120. The one or more parameters may be indicated via respective information elements (IEs) included in a capability report.

The capability information may indicate whether the UE 120 supports a feature and/or one or more parameters related to the feature. For example, the capability information may indicate a capability and/or parameter for supporting a signal quality equivalence based precoding for wireless messages. In other words, the capability information may indicate that the UE 120 is capable of decoding wireless messages that are precoded in accordance with signal quality equivalence across a set of spatial layers of a transmission channel (e.g., a GMD precoder and/or a UCD precoder). In some examples, the capability information may indicate a capability and/or parameter that indicates that the UE 120 includes a reception component that supports one or more of GMD or UCD (such as a reception component 802). One or more operations described herein may be based on the capability information. For example, the UE 120 may perform one or more operations of example 500 in accordance with the capability information or may receive configuration information that is in accordance with the capability information.

The network node 110 may determine configuration information for the UE 120 based on the capability information. For example, the network node 110 may determine that the UE 120 is to be enabled to decode and/or de-map wireless messages that are precoded using GMD and/or UCD precoding techniques based on the capability information.

In a second operation 510, the network node 110 may optionally transmit, and the UE 120 may receive, the configuration information. In some aspects, the UE 120 may receive the configuration information via one or more of system information signaling (e.g., a master information block (MIB) and/or a SIB, among other examples), RRC signaling, MAC signaling (e.g., one or more MAC-CEs), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may indicate a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some examples, the configuration information indicates that signal quality equivalence based precoding may be enabled. For example, the configuration information may indicate that a GMD or UCD precoder is applied for one or more subsequent wireless transmissions. Therefore, the UE 120 may use one or more receiving operations associated with GMD or UCD precoding (e.g., use a corresponding demapper). For example, rather than using a demapper associated with SVD precoding and/or open loop precoding (e.g., a minimum mean square error (MMSE) demapper), the UE 120 may operate in accordance with a demapper associated with GMD and/or UCD (e.g., a vBLAST demapper, a DFE demapper, a PSRD demapper, or any other QR decomposition based demapper).

In some examples, the configuration information further indicates that one or more CSI parameters for subsequent CSI reporting may be associated with equalizing the signal quality across a set of spatial layers of a transmission channel. For example, the configuration information may indicate and/or configure a CSI report that supports reporting PMI, RI, and/or CQI for GMD and/or UCD precoding. In some examples, the CSI report may be an example of a type-1 CSI report.

In a third operation 515, the UE 120 may optionally transmit, and the network node 110 may receive, one or more SRSs. In some examples, the one or more SRSs may be periodic (e.g., configured via the configuration information). In some examples, the one or more SRSs may be aperiodic. For instance, the network node 110 may transmit, and the UE 120 may receive, dynamic control signaling (such as MAC signaling and/or DCI signaling) that triggers transmission of the one or more SRSs.

In a fourth operation 520, the network node 110 may optionally transmit, and the UE 120 may receive, control information (e.g., a triggering DCI) that indicates whether one or more subsequent CSI reports may include one or more of a first set of CSI parameters or a second set of CSI parameters. In some examples, the first set of CSI parameters may be associated with SVD and/or open loop based precoding. In some examples, the first set of CSI parameters may be referred to herein as “legacy” or “traditional” CSI parameters. In some examples, the first set of CSI parameters may include one or more of a PMI, an RI, or a CQI associated with SVD and/or open loop based precoding. In some examples, the second set of parameters may include one or more of an RI or a CQI associated with GMD/UCD precoding.

Based on the control information indicating whether a CSI report should include the first set of CSI parameters, the second set of CSI parameters, or both, the network node 110 may dynamically reduce signaling overhead associated with the CSI report. For example, the network node 110 may determine the channel condition in accordance with receiving the one or more SRSs. In accordance with estimating the channel condition estimated from the one or more SRSs, the network node 110 may determine that GMD and/or UCD precoding may result in a higher channel quality of the transmission channel compared to SVD based precoding, and therefore the control information may request the second set of CSI parameters and not the first set of CSI parameters (e.g., or vice versa if SVD based precoding results in higher channel quality). Therefore, the network node 110 may reduce the signaling overhead associated with the CSI report and reduce CSI computation power at the UE 120 associated with computing CSI parameters.

In a fifth operation 525, the network node 110 may transmit, and the UE 120 may receive, one or more reference signals associated with measurement of a signal quality associated with a transmission channel, where the transmission channel may be associated with a set of spatial layers. In some examples, the one or more reference signals may be CSI-RSs. In some other examples, the one or more reference signals may be one or more of SSBs, DMRSs, or PTRSs as described in FIG. 3.

In a sixth operation 530, the UE 120 may transmit, and the network node 110 may receive, a CSI report. For example, the CSI report may be associated with the transmission channel and may indicate one or more CSI parameters associated with equalizing signal quality across the set of spatial layers in accordance with supporting the signal quality equivalence based precoding. In some examples, the CSI report may be periodic (e.g., configured via the configuration information). In some examples, the CSI report may be aperiodic. For example, the control information (in the fourth operation 520) may trigger transmission of the CSI report, or the network node 110 may transmit separate dynamic control signaling (e.g., MAC signaling and/or DCI signaling) that triggers transmission of the CSI report.

In some examples, the CSI report may include a single set of CSI parameters. For example, the single set of CSI parameters may include a PMI that indicates a signal quality equivalence precoder (e.g., a GMD or UCD precoder), an RI associated with the PMI, and a CQI (e.g., indicating a code rate and QAM order) associated with the PMI. In some examples, the UE 120 may determine the single set of CSI parameters based on performing one or more CSI computations associated with GMD and/or UCD. In some examples, the PMI may be from a set of PMIs that includes one or more codebook based precoders, one or more signal quality equivalence precoders (e.g., GMD and/or UCD), or one or more SVD precoders. In some examples, the CSI report may indicate the PMI by including one or more bits that indicate an index from a configured set of PMI indexes (e.g., defined in a wireless communications standard, such as 3GPP) that indicates GMD or UCD based precoding.

In some examples, the single set of CSI parameters may include a PMI that indicates an SVD or open loop precoder, an RI associated with the PMI, and a CQI (e.g., indicating a code rate and QAM order) associated with the PMI. In other words, the PMI indicated in the single set of CSI parameters may indicate a codebook based precoder, a GMD/UCD precoder, or an SVD precoder. In some examples, the UE 120 may perform one or more CSI computations to compare the different types of precoders, and may select the precoder type that the UE 120 estimates to result in a highest decoding probability for subsequent wireless messages (e.g., a highest efficiency precoder). Therefore, by transmitting a single set of CSI parameters, the UE 120 may reduce signaling overhead for the CSI report and may select the highest efficiency precoder for the transmission channel.

In some examples, the CSI report may include the first set of CSI parameters (e.g., the legacy or traditional CSI parameters) and/or the second set of CSI parameters (e.g., the GMD/UCD CSI parameters). In some examples, the PMI included in the first set of CSI parameters may include a codepoint that indicates that GMD and/or UCD precoding is preferred over precoding in accordance with the first set of CSI parameters. In cases where the CSI report includes both the first set of CSI parameters and the second set of CSI parameters, the network node 110 may be able to choose between the different possible types of precoding. Therefore, the network node 110 may be able to dynamically select a precoding type in accordance with changes in the transmission channel quality.

In a seventh operation 535, the network node 110 may optionally precode a wireless message in accordance with the one or more CSI parameters of the CSI report. For instance, the network node 110 may precode the wireless message using a precoder associated with signal quality equivalence across the set of spatial layers of the transmission channel. In some examples, the seventh operation 535 may include and/or be associated with one or more operations of the channel coding process 405, as described with reference to FIG. 4.

In an eighth operation 540, the network node 110 may optionally transmit, and the UE 120 may receive, a wireless message. For example, the wireless message may be precoded in accordance with signal quality equivalence across a set of spatial layers.

In a ninth operation 545, the UE 120 may optionally decode/de-map the wireless message in accordance with signal quality based precoding. For example, the UE 120 may use a QR decomposition based demapper to decode the wireless message. In some examples, the ninth operation 545 may include and/or be associated with one or more operations of the demapper 430, as described with reference to FIG. 4.

In a tenth operation 550, the UE 120 may optionally transmit, and the network node 110 may receive, an ACK/NACK indication for the wireless message. For example, if the UE 120 successfully decoded the wireless message, then the UE 120 may transmit an ACK indication. If, however, the UE 120 did not successfully receive and/or decode the wireless message, the UE 120 may transmit a NACK indication. If the network node 110 receives the NACK indication, then the network node 110 may retransmit the wireless message. In some examples, the network node 110 may retransmit the wireless message using a same type of precoder. In some examples, the network node 110 may retransmit the wireless message using a different type of precoder. For instance, if the network node 110 used an SVD precoder for the initial transmission of the wireless message, then the network node 110 may use a GMD or UCD precoder for the retransmission of the wireless message.

As indicated above, FIG. 5 is provided as an example. Other examples may differ from what is described with regard to FIG. 5.

FIG. 6 is a diagram illustrating an example process 600 performed, for example, at a UE or an apparatus of a UE, in accordance with the present disclosure. Example process 600 is an example where the apparatus or the UE (e.g., UE 120) performs operations associated with signal quality equivalence based precoding for wireless devices.

As shown in FIG. 6, in some aspects, process 600 may include transmitting, to a network node, capability information that indicates support for a signal quality equivalence based precoding for wireless messages (block 610). For example, the UE (e.g., using transmission component 804 and/or communication manager 806, depicted in FIG. 8) may transmit, to a network node, capability information that indicates support for a signal quality equivalence based precoding for wireless messages, as described above.

As further shown in FIG. 6, in some aspects, process 600 may include receiving, from the network node, one or more reference signals associated with measurement of a signal quality associated with a transmission channel, wherein the transmission channel is associated with a set of spatial layers (block 620). For example, the UE (e.g., using reception component 802 and/or communication manager 806, depicted in FIG. 8) may receive, from the network node, one or more reference signals associated with measurement of a signal quality associated with a transmission channel, wherein the transmission channel is associated with a set of spatial layers, as described above.

As further shown in FIG. 6, in some aspects, process 600 may include transmitting, to the network node, a CSI report associated with the transmission channel that indicates one or more CSI parameters associated with equalizing signal quality across the set of spatial layers in accordance with supporting the signal quality equivalence based precoding (block 630). For example, the UE (e.g., using transmission component 804 and/or communication manager 806, depicted in FIG. 8) may transmit, to the network node, a CSI report associated with the transmission channel that indicates one or more CSI parameters associated with equalizing signal quality across the set of spatial layers in accordance with supporting the signal quality equivalence based precoding, as described above.

Process 600 may include additional aspects, such as any single aspect or any combination of aspects described below and/or in connection with one or more other processes described elsewhere herein.

In a first aspect, the capability information indicates that the UE includes a reception component that supports one or more of GMD or UCD.

In a second aspect, alone or in combination with the first aspect, process 600 includes receiving, from the network node and based at least in part on the capability information, configuration information that indicates that the signal quality equivalence based precoding is enabled.

In a third aspect, alone or in combination with one or more of the first and second aspects, the configuration information further indicates that the one or more CSI parameters are associated with equalizing the signal quality across the set of spatial layers.

In a fourth aspect, alone or in combination with one or more of the first through third aspects, the CSI report comprises a single set of CSI parameters that includes the one or more CSI parameters, and the single set of CSI parameters includes a PMI that indicates a signal quality equivalence based precoder, an RI associated with the PMI, and CQI associated with the PMI.

In a fifth aspect, alone or in combination with one or more of the first through fourth aspects, the PMI is from a set of PMIs that includes one or more codebook based precoders, one or more signal quality equivalence based precoders, or one or more SVD based precoders.

In a sixth aspect, alone or in combination with one or more of the first through fifth aspects, the CSI report includes a first set of CSI parameters and a second set of CSI parameters, and the second set of CSI parameters includes the one or more CSI parameters associated with equalizing the signal quality across the set of spatial layers.

In a seventh aspect, alone or in combination with one or more of the first through sixth aspects, the first set of CSI parameters includes a PMI, a first RI associated the PMI, and a first CQI associated with the PMI, and the second set of CSI parameters includes a second RI associated with equalizing the signal quality across the set of spatial layers and a second CQI equalizing the signal quality across the set of spatial layers.

In an eighth aspect, alone or in combination with one or more of the first through seventh aspects, the PMI includes a codepoint that indicates that a precoder associated with the second set of CSI parameters is preferred over a precoder associated with the first set of CSI parameters.

In a ninth aspect, alone or in combination with one or more of the first through eighth aspects, the first set of CSI parameters is associated with SVD or open loop CSI reporting and the second set of CSI parameters is associated with GMD or UCD.

In a tenth aspect, alone or in combination with one or more of the first through ninth aspects, process 600 includes receiving, from the network node prior to transmission of the CSI report, control information that indicates whether the CSI report is to include one or more of a first set of CSI parameters or a second set of CSI parameters, wherein the second set of CSI parameters are associated with equalizing the signal quality across the set of spatial layers.

In an eleventh aspect, alone or in combination with one or more of the first through tenth aspects, process 600 includes transmitting, to the network node, one or more SRSs, wherein the control information is based at least in part on transmission of the one or more SRSs.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node, in accordance with the present disclosure. Example process 700 is an example where the apparatus or the network node (e.g., network node 110) performs operations associated with signal quality equivalence based precoding for wireless devices.

As shown in FIG. 7, in some aspects, process 700 may include receiving, from a UE, capability information that indicates support for a signal quality equivalence based precoding for wireless messages (block 710). For example, the network node (e.g., using reception component 902 and/or communication manager 906, depicted in FIG. 9) may receive, from a UE, capability information that indicates support for a signal quality equivalence based precoding for wireless messages, as described above.

As further shown in FIG. 7, in some aspects, process 700 may include transmitting, to the UE, one or more reference signals associated with measurement of a signal quality associated with a transmission channel, wherein the transmission channel is associated with a set of spatial layers (block 720). For example, the network node (e.g., using transmission component 904 and/or communication manager 906, depicted in FIG. 9) may transmit, to the UE, one or more reference signals associated with measurement of a signal quality associated with a transmission channel, wherein the transmission channel is associated with a set of spatial layers, as described above.

As further shown in FIG. 7, in some aspects, process 700 may include receiving, from the UE, a CSI report associated with the transmission channel that indicates one or more CSI parameters associated with equalizing signal quality across the set of spatial layers in accordance with supporting the signal quality equivalence based precoding (block 730). For example, the network node (e.g., using reception component 902 and/or communication manager 906, depicted in FIG. 9) may receive, from the UE, a CSI report associated with the transmission channel that indicates one or more CSI parameters associated with equalizing signal quality across the set of spatial layers in accordance with supporting the signal quality equivalence based precoding, as described above.

Process 700 may include additional aspects, such as any single aspect or any combination of aspects described below and/or in connection with one or more other processes described elsewhere herein.

In a first aspect, the capability information indicates that the UE includes a reception component that supports one or more of GMD or UCD.

In a second aspect, alone or in combination with the first aspect, process 700 includes transmitting, to the UE and based at least in part on the capability information, configuration information that indicates that the signal quality equivalence based precoding is enabled.

In a third aspect, alone or in combination with one or more of the first and second aspects, the configuration information further indicates that the one or more CSI parameters are associated with equalizing the signal quality across the set of spatial layers.

In a fourth aspect, alone or in combination with one or more of the first through third aspects, the CSI report comprises a single set of CSI parameters that includes the one or more CSI parameters, and the single set of CSI parameters includes a PMI that indicates a signal quality equivalence based precoder, an RI associated with the PMI, and CQI associated with the PMI.

In a fifth aspect, alone or in combination with one or more of the first through fourth aspects, the PMI is from a set of PMIs that includes one or more codebook based precoders, one or more signal quality equivalence based precoders, or one or more SVD based precoders.

In a sixth aspect, alone or in combination with one or more of the first through fifth aspects, the CSI report includes a first set of CSI parameters and a second set of CSI parameters, and the second set of CSI parameters includes the one or more CSI parameters associated with equalizing the signal quality across the set of spatial layers.

In a seventh aspect, alone or in combination with one or more of the first through sixth aspects, the first set of CSI parameters includes a PMI, a first RI associated the PMI, and a first CQI associated with the PMI, and the second set of CSI parameters includes a second RI associated with equalizing the signal quality across the set of spatial layers and a second CQI equalizing the signal quality across the set of spatial layers.

In an eighth aspect, alone or in combination with one or more of the first through seventh aspects, the PMI includes a codepoint that indicates that a precoder associated with the second set of CSI parameters is preferred over a precoder associated with the first set of CSI parameters.

In a ninth aspect, alone or in combination with one or more of the first through eighth aspects, the first set of CSI parameters is associated with SVD or open loop CSI reporting and the second set of CSI parameters is associated with GMD or UCD.

In a tenth aspect, alone or in combination with one or more of the first through ninth aspects, process 700 includes transmitting, to the UE prior to reception of the CSI report, control information that indicates whether the CSI report is to include one or more of a first set of CSI parameters or a second set of CSI parameters, wherein the second set of CSI parameters are associated with equalizing the signal quality across the set of spatial layers.

In an eleventh aspect, alone or in combination with one or more of the first through tenth aspects, process 700 includes receiving, from the UE, one or more SRSs via the transmission channel, wherein the control information is based at least in part on a channel quality associated with reception of the one or more SRSs.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 3 through 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The transmission component 804 may transmit, to a network node, capability information that indicates support for a signal quality equivalence based precoding for wireless messages. The reception component 802 may receive, from the network node, one or more reference signals associated with measurement of a signal quality associated with a transmission channel, where the transmission channel is associated with a set of spatial layers. The transmission component 804 may transmit, to the network node, a CSI report associated with the transmission channel that indicates one or more CSI parameters associated with equalizing signal quality across the set of spatial layers in accordance with supporting the signal quality equivalence based precoding.

The reception component 802 may receive, from the network node and based at least in part on the capability information, configuration information that indicates that the signal quality equivalence based precoding is enabled.

The reception component 802 may receive, from the network node prior to transmission of the CSI report, control information that indicates whether the CSI report is to include one or more of a first set of CSI parameters or a second set of CSI parameters, where the second set of CSI parameters are associated with equalizing the signal quality across the set of spatial layers.

The transmission component 804 may transmit, to the network node, one or more SRSs, where the control information is based at least in part on transmission of the one or more SRSs.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 3 through 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive, from a UE, capability information that indicates support for a signal quality equivalence based precoding for wireless messages. The transmission component 904 may transmit, to the UE, one or more reference signals associated with measurement of a signal quality associated with a transmission channel, where the transmission channel is associated with a set of spatial layers. The reception component 902 may receive, from the UE, a CSI report associated with the transmission channel that indicates one or more CSI parameters associated with equalizing signal quality across the set of spatial layers in accordance with supporting the signal quality equivalence based precoding.

The transmission component 904 may transmit, to the UE and based at least in part on the capability information, configuration information that indicates that the signal quality equivalence based precoding is enabled.

The transmission component 904 may transmit, to the UE prior to reception of the CSI report, control information that indicates whether the CSI report is to include one or more of a first set of CSI parameters or a second set of CSI parameters, where the second set of CSI parameters are associated with equalizing the signal quality across the set of spatial layers.

The reception component 902 may receive, from the UE, one or more SRSs via the transmission channel, where the control information is based at least in part on a channel quality associated with reception of the one or more SRSs.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: transmitting, to a network node, capability information that indicates support for a signal quality equivalence based precoding for wireless messages; receiving, from the network node, one or more reference signals associated with measurement of a signal quality associated with a transmission channel, wherein the transmission channel is associated with a set of spatial layers; and transmitting, to the network node, a channel state information (CSI) report associated with the transmission channel that indicates one or more CSI parameters associated with equalizing signal quality across the set of spatial layers in accordance with supporting the signal quality equivalence based precoding.

Aspect 2: The method of Aspect 1, wherein the capability information indicates that the UE includes a reception component that supports one or more of geometric mean decomposition (GMD) or uniform channel decomposition (UCD).

Aspect 3: The method of any of Aspects 1-2, further comprising: receiving, from the network node and based at least in part on the capability information, configuration information that indicates that the signal quality equivalence based precoding is enabled.

Aspect 4: The method of Aspect 3, wherein the configuration information further indicates that the one or more CSI parameters are associated with equalizing the signal quality across the set of spatial layers.

Aspect 5: The method of any of Aspects 1-4, wherein the CSI report comprises a single set of CSI parameters that includes the one or more CSI parameters, and wherein the single set of CSI parameters includes a precoding matrix indicator (PMI) that indicates a signal quality equivalence based precoder, a rank indicator (RI) associated with the PMI, and channel quality indicator (CQI) associated with the PMI.

Aspect 6: The method of Aspect 5, wherein the PMI is from a set of PMIs that includes one or more codebook based precoders, one or more signal quality equivalence based precoders, or one or more single value decomposition (SVD) based precoders.

Aspect 7: The method of any of Aspects 1-6, wherein the CSI report includes a first set of CSI parameters and a second set of CSI parameters, and wherein the second set of CSI parameters includes the one or more CSI parameters associated with equalizing the signal quality across the set of spatial layers.

Aspect 8: The method of Aspect 7, wherein: the first set of CSI parameters includes a precoding matrix indicator (PMI), a first rank indicator (RI) associated the PMI, and a first channel quality indicator (CQI) associated with the PMI, and the second set of CSI parameters includes a second RI associated with equalizing the signal quality across the set of spatial layers and a second CQI equalizing the signal quality across the set of spatial layers.

Aspect 9: The method of Aspect 8, wherein the PMI includes a codepoint that indicates that a precoder associated with the second set of CSI parameters is preferred over a precoder associated with the first set of CSI parameters.

Aspect 10: The method of Aspect 7, wherein the first set of CSI parameters is associated with single value decomposition (SVD) or open loop CSI reporting and the second set of CSI parameters is associated with geometric mean decomposition (GMD) or uniform channel decomposition (UCD).

Aspect 11: The method of any of Aspects 1-10, further comprising: receiving, from the network node prior to transmission of the CSI report, control information that indicates whether the CSI report is to include one or more of a first set of CSI parameters or a second set of CSI parameters, wherein the second set of CSI parameters are associated with equalizing the signal quality across the set of spatial layers.

Aspect 12: The method of Aspect 11, further comprising: transmitting, to the network node, one or more sounding reference signals (SRSs), wherein the control information is based at least in part on transmission of the one or more SRSs.

Aspect 13: A method of wireless communication performed by a network node, comprising: receiving, from a user equipment (UE), capability information that indicates support for a signal quality equivalence based precoding for wireless messages; transmitting, to the UE, one or more reference signals associated with measurement of a signal quality associated with a transmission channel, wherein the transmission channel is associated with a set of spatial layers; and receiving, from the UE, a channel state information (CSI) report associated with the transmission channel that indicates one or more CSI parameters associated with equalizing signal quality across the set of spatial layers in accordance with supporting the signal quality equivalence based precoding.

Aspect 14: The method of Aspect 13, wherein the capability information indicates that the UE includes a reception component that supports one or more of geometric mean decomposition (GMD) or uniform channel decomposition (UCD).

Aspect 15: The method of any of Aspects 13-14, further comprising: transmitting, to the UE and based at least in part on the capability information, configuration information that indicates that the signal quality equivalence based precoding is enabled.

Aspect 16: The method of Aspect 15, wherein the configuration information further indicates that the one or more CSI parameters are associated with equalizing the signal quality across the set of spatial layers.

Aspect 17: The method of any of Aspects 13-16, wherein the CSI report comprises a single set of CSI parameters that includes the one or more CSI parameters, and wherein the single set of CSI parameters includes a precoding matrix indicator (PMI) that indicates a signal quality equivalence based precoder, a rank indicator (RI) associated with the PMI, and channel quality indicator (CQI) associated with the PMI.

Aspect 18: The method of Aspect 17, wherein the PMI is from a set of PMIs that includes one or more codebook based precoders, one or more signal quality equivalence based precoders, or one or more single value decomposition (SVD) based precoders.

Aspect 19: The method of any of Aspects 13-18, wherein the CSI report includes a first set of CSI parameters and a second set of CSI parameters, and wherein the second set of CSI parameters includes the one or more CSI parameters associated with equalizing the signal quality across the set of spatial layers.

Aspect 20: The method of Aspect 19, wherein: the first set of CSI parameters includes a precoding matrix indicator (PMI), a first rank indicator (RI) associated the PMI, and a first channel quality indicator (CQI) associated with the PMI, and the second set of CSI parameters includes a second RI associated with equalizing the signal quality across the set of spatial layers and a second CQI equalizing the signal quality across the set of spatial layers.

Aspect 21: The method of Aspect 20, wherein the PMI includes a codepoint that indicates that a precoder associated with the second set of CSI parameters is preferred over a precoder associated with the first set of CSI parameters.

Aspect 22: The method of Aspect 19, wherein the first set of CSI parameters is associated with single value decomposition (SVD) or open loop CSI reporting and the second set of CSI parameters is associated with geometric mean decomposition (GMD) or uniform channel decomposition (UCD).

Aspect 23: The method of any of Aspects 13-22, further comprising: transmitting, to the UE prior to reception of the CSI report, control information that indicates whether the CSI report is to include one or more of a first set of CSI parameters or a second set of CSI parameters, wherein the second set of CSI parameters are associated with equalizing the signal quality across the set of spatial layers.

Aspect 24: The method of Aspect 23, further comprising: receiving, from the UE, one or more sounding reference signals (SRSs) via the transmission channel, wherein the control information is based at least in part on a channel quality associated with reception of the one or more SRSs.

Aspect 25: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-24.

Aspect 26: An apparatus for wireless communication at a device, the apparatus comprising one or more memories and one or more processors coupled to the one or more memories, the one or more processors configured to cause the device to perform the method of one or more of Aspects 1-24.

Aspect 27: An apparatus for wireless communication, the apparatus comprising at least one means for performing the method of one or more of Aspects 1-24.

Aspect 28: A non-transitory computer-readable medium storing code for wireless communication, the code comprising instructions executable by one or more processors to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

Aspect 30: A device for wireless communication, the device comprising a processing system that includes one or more processors and one or more memories coupled with the one or more processors, the processing system configured to cause the device to perform the method of one or more of Aspects 1-24.

Aspect 31: An apparatus for wireless communication at a device, the apparatus comprising one or more memories and one or more processors coupled to the one or more memories, the one or more processors individually or collectively configured to cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, which are configured, individually or in any combination, to:
transmit, to a network node, capability information that indicates support for a signal quality equivalence based precoding for wireless messages;
receive, from the network node, one or more reference signals associated with measurement of a signal quality associated with a transmission channel, wherein the transmission channel is associated with a set of spatial layers; and
transmit, to the network node, a channel state information (CSI) report associated with the transmission channel that indicates one or more CSI parameters associated with equalizing signal quality across the set of spatial layers in accordance with supporting the signal quality equivalence based precoding.

2. The UE of claim 1, wherein the capability information indicates that the UE includes a reception component that supports one or more of geometric mean decomposition (GMD) or uniform channel decomposition (UCD).

3. The UE of claim 1, wherein the one or more processors are further configured, individually or in any combination, to:
receive, from the network node and based at least in part on the capability information, configuration information that indicates that the signal quality equivalence based precoding is enabled.

4. The UE of claim 3, wherein the configuration information further indicates that the one or more CSI parameters are associated with equalizing the signal quality across the set of spatial layers.

5. The UE of claim 1, wherein the CSI report comprises a single set of CSI parameters that includes the one or more CSI parameters, and wherein the single set of CSI parameters includes a precoding matrix indicator (PMI) that indicates a signal quality equivalence based precoder, a rank indicator (RI) associated with the PMI, and channel quality indicator (CQI) associated with the PMI.

6. The UE of claim 5, wherein the PMI is from a set of PMIs that includes one or more codebook based precoders, one or more signal quality equivalence based precoders, or one or more single value decomposition (SVD) based precoders.

7. The UE of claim 1, wherein the CSI report includes a first set of CSI parameters and a second set of CSI parameters, and wherein the second set of CSI parameters includes the one or more CSI parameters associated with equalizing the signal quality across the set of spatial layers.

8. The UE of claim 7, wherein:
the first set of CSI parameters includes a precoding matrix indicator (PMI), a first rank indicator (RI) associated the PMI, and a first channel quality indicator (CQI) associated with the PMI, and
the second set of CSI parameters includes a second RI associated with equalizing the signal quality across the set of spatial layers and a second CQI equalizing the signal quality across the set of spatial layers.

9. The UE of claim 8, wherein the PMI includes a codepoint that indicates that a precoder associated with the second set of CSI parameters is preferred over a precoder associated with the first set of CSI parameters.

10. The UE of claim 7, wherein the first set of CSI parameters is associated with single value decomposition (SVD) or open loop CSI reporting and the second set of CSI parameters is associated with geometric mean decomposition (GMD) or uniform channel decomposition (UCD).

11. The UE of claim 1, wherein the one or more processors are further configured, individually or in any combination, to:
receive, from the network node prior to transmission of the CSI report, control information that indicates whether the CSI report is to include one or more of a first set of CSI parameters or a second set of CSI parameters, wherein the second set of CSI parameters are associated with equalizing the signal quality across the set of spatial layers.

12. The UE of claim 11, wherein the one or more processors are further configured, individually or in any combination, to:
transmit, to the network node, one or more sounding reference signals (SRSs), wherein the control information is based at least in part on transmission of the one or more SRSs.

13. A method of wireless communication performed by a user equipment (UE), comprising:
transmitting, to a network node, capability information that indicates support for a signal quality equivalence based precoding for wireless messages;
receiving, from the network node, one or more reference signals associated with measurement of a signal quality associated with a transmission channel, wherein the transmission channel is associated with a set of spatial layers; and
transmitting, to the network node, a channel state information (CSI) report associated with the transmission channel that indicates one or more CSI parameters associated with equalizing signal quality across the set of spatial layers in accordance with supporting the signal quality equivalence based precoding.

14. The method of claim 13, wherein the capability information indicates that the UE includes a reception component that supports one or more of geometric mean decomposition (GMD) or uniform channel decomposition (UCD).

15. The method of claim 13, further comprising:
receiving, from the network node and based at least in part on the capability information, configuration information that indicates that the signal quality equivalence based precoding is enabled.

16. The method of claim 15, wherein the configuration information further indicates that the one or more CSI parameters are associated with equalizing the signal quality across the set of spatial layers.

17. The method of claim 13, wherein the CSI report comprises a single set of CSI parameters that includes the one or more CSI parameters, and wherein the single set of CSI parameters includes a precoding matrix indicator (PMI) that indicates a signal quality equivalence based precoder, a rank indicator (RI) associated with the PMI, and channel quality indicator (CQI) associated with the PMI.

18. The method of claim 17, wherein the PMI is from a set of PMIs that includes one or more codebook based precoders, one or more signal quality equivalence based precoders, or one or more single value decomposition (SVD) based precoders.

19. The method of claim 13, wherein the CSI report includes a first set of CSI parameters and a second set of CSI parameters, and wherein the second set of CSI parameters includes the one or more CSI parameters associated with equalizing the signal quality across the set of spatial layers.

20. An apparatus for wireless communication, comprising:
means for transmitting, to a network node, capability information that indicates support for a signal quality equivalence based precoding for wireless messages;
means for receiving, from the network node, one or more reference signals associated with measurement of a signal quality associated with a transmission channel, wherein the transmission channel is associated with a set of spatial layers; and
means for transmitting, to the network node, a channel state information (CSI) report associated with the transmission channel that indicates one or more CSI parameters associated with equalizing signal quality across the set of spatial layers in accordance with supporting the signal quality equivalence based precoding.
